(19) United States
(12) Patent Application Publication
(10) Pub. No.: US 2013/0212616 A1
(43) Pub. Date: Aug. 15, 2013

(54) METHOD AND SYSTEM FOR CONFIGURING A USER INTERFACE OF A RECEIVING UNIT FOR AN AUXILIARY REMOTE CONTROL DEVICE

(71) Applicants: Philip J. Goswitz, Rancho Palos Verdes, CA (US); Jorge H. Guzman, Gaithersburg, MD (US); Benjamin Mui, Los Angeles, CA (US); David N. Schlacht, Los Angeles, CA (US); Joseph Santoru, Agoura Hills, CA (US); John L. Norin, Redondo Beach, CA (US); Shannon A. Kallin, Santa Monica, CA (US); Sean S. Lee, Potomac, MD (US); Drew T. Chen, Gaithersburg, MD (US); Scott D. Casavant, Germantown, MD (US)

(72) Inventors: Philip J. Goswitz, Rancho Palos Verdes, CA (US); Jorge H. Guzman, Gaithersburg, MD (US); Benjamin Mui, Los Angeles, CA (US); David N. Schlacht, Los Angeles, CA (US); Joseph Santoru, Agoura Hills, CA (US); John L. Norin, Redondo Beach, CA (US); Shannon A. Kallin, Santa Monica, CA (US); Sean S. Lee, Potomac, MD (US); Drew T. Chen, Gaithersburg, MD (US); Scott D. Casavant, Germantown, MD (US)

(73) Assignee: The DIRECTV Group, Inc., El Segundo, CA (US)

(21) Appl. No.: 13/569,102

(22) Filed: Aug. 7, 2012

Related U.S. Application Data
(60) Provisional application No. 61/521,257, filed on Aug. 8, 2011.

(51) Int. Cl. H04N 21/454

(52) U.S. Cl. CPC H04N 21/454
USPC 725/28

(57) ABSTRACT

A system and method for controlling a user interface comprises an auxiliary remote control device having an auxiliary remote control device identifier associated therewith and a receiving unit comprising a filter module having a filter feature for filtering content data from a set of available content data in response to an auxiliary remote control device identifier received at the receiving unit. The filter module forms filtered available content data less than the set of available content data. The receiving unit displays the user interface having the filtered available content data associated with the auxiliary remote control device on a display associated with the receiving unit.

### TECHNICAL FIELD

The present disclosure relates generally to a receiving device and a user interface generated by the receiving device and, more specifically, to a method and system for configuring the user interface of the receiving device specifically for use with an auxiliary remote control device.

### BACKGROUND

The statements in this section merely provide background information related to the present disclosure and may not constitute prior art.

Content providers such as cable and satellite television providers provide a variety of programming to meet the interests of a variety of customers. This includes content provided in live television, recorded television, pay-per-view, and on-demand. Because of the wide variety of content, all of the content may not be suitable for all of the customers. For example, some programming may have mature themes not suitable for children.

Set top boxes typically provide a way to restrict access to content having a mature rating. Typically, a secret code must be entered in order to access the content. However, a grid guide, which is complex for young children, is typically provided. A grid guide may not be suitable for young children since many young children are unable to read. Set top boxes typically provide various settings that may be configured during the setup process. The settings are time-consuming to configure. One problem with multiple users is that settings may be inadvertently changed. Small children may press various buttons on the remote control device that allows the settings to be changed inadvertently. Resetting the settings may be time-consuming.

### SUMMARY

The present disclosure provides a system and method for providing a system and method for providing filtered content choices. The system is particularly suitable for children but may be applied to other contexts.

In one aspect of the disclosure, a method of operating a receiving unit comprises selecting a filter feature for filtering content data from a set of available content data for use with an auxiliary remote control device, receiving an auxiliary remote control device identifier from auxiliary remote control device at a receiving unit, in response to receiving the auxiliary remote control device identifier, filtering the set of available content data with the filter feature to form filtered available content data less than the set of available content data and displaying a user interface having the filtered available content data associated with the auxiliary remote control device on a display.

In another aspect of the disclosure, a system and method for controlling a user interface comprises an auxiliary remote control device having an auxiliary remote control device identifier associated therewith and a receiving unit comprising a filter module having a filter feature for filtering content data from a set of available content data in response to an auxiliary remote control device identifier received at the receiving unit. The filter module forms filtered available content data less than the set of available content data. The receiving unit displays the user interface having the filtered available content data associated with the auxiliary remote control device on a display associated with the receiving unit.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a block diagrammatic system view of a communication system according to the present disclosure.

FIG. 2 is a detailed block diagrammatic view of a receiving unit of FIG. 1.

FIG. 3 is a plan view of a primary remote control device.

FIG. 4 is a plan view of an auxiliary remote control device.

FIG. 5 is a block diagrammatic view of a remote control device.

FIG. 6 is a representation of a control word generated by a remote control device.

FIG. 7 is a detailed block diagrammatic view of the controller of FIG. 2.

FIG. 8 is a flowchart of a method for configuring an auxiliary mode for operation with an auxiliary remote control device.

FIG. 9 is a flowchart of a method for operating the receiving unit in an auxiliary mode.

FIG. 10A is a representation of a primary key value table.

FIG. 10B is a representation of an auxiliary key value table.

FIG. 11 is a flowchart of a method for operating the receiving unit in response to an auxiliary remote control identifier.

FIG. 12 is a screen display for choosing ratings in a setup wizard of an auxiliary remote control operation.

FIG. 13 is a screen display of a method for setting time limits for the setup wizard.

FIG. 14 is a screen display of a method for setting kids channels for the setup wizard.

FIG. 15 is a screen display for setting family and educational channels of the setup wizard.

FIG. 16 is a screen display of a method for setting local channels of the setup wizard.

FIG. 17 is a screen display of a user interface associated with an auxiliary remote control device.

FIG. 18 is a schematic view of a system for testing the operation of an auxiliary remote control device.

FIG. 19 is a flowchart for a method for testing the operation of a remote control device.

### DETAILED DESCRIPTION

The following description is merely exemplary in nature and is not intended to limit the present disclosure, application, or uses. For purposes of clarity, the same reference numbers will be used in the drawings to identify similar elements. As used herein, the term module refers to an Application Specific Integrated Circuit (ASIC), an electronic circuit, a processor (shared, dedicated, or group) and memory that execute one or more software or firmware programs, a combinational logic circuit, and/or other suitable components that provide the described functionality. As used herein, the phrase at least one of A, B, and C should be construed to mean a logical (A or B or C), using a non-exclusive logical OR. It should be understood that steps within a method may be executed in different order without altering the principles of the present disclosure.

While the following disclosure is made with respect to example DIRECTV® broadcast services and systems, it should be understood that many other delivery systems are readily applicable to disclosed systems and methods. Such systems include wireless terrestrial distribution systems, wired or cable distribution systems, cable television distribution systems, Ultra High Frequency (UHF)/Very High Frequency (VHF) radio frequency systems or other terrestrial broadcast systems (e.g., Multi-channel Multi-point Distribution System (MMDS), Local Multi-point Distribution System (LMDS), etc.), Internet-based distribution systems, cellular distribution systems, power-line broadcast systems, any point-to-point and/or multicast Internet Protocol (IP) delivery network, and fiber optic networks. Further, the different functions collectively allocated among a service provider and integrated receiver/decoders (IRDs) as described below can be reallocated as desired without departing from the intended scope of the present patent.

Further, while the following disclosure is made with respect to the delivery of content (e.g., television (TV), movies, games, music videos, etc.), it should be understood that the systems and methods disclosed herein could also be used for delivery of any media content type, for example, audio, music, data files, web pages, games, etc. Additionally, throughout this disclosure reference is made to data, information, programs, movies, assets, video data, etc., however, it will be readily apparent to persons of ordinary skill in the art that these terms are substantially equivalent in reference to the example systems and/or methods disclosed herein. The content has content data associated therewith such as titles, channels, times, descriptions and other data that is used to form a program guide or other user interface. The program guide or user interface has a set of available content data which is a large set of data. The present disclosure filters the set of available content data to form a filtered available content data set less than the entire available set.

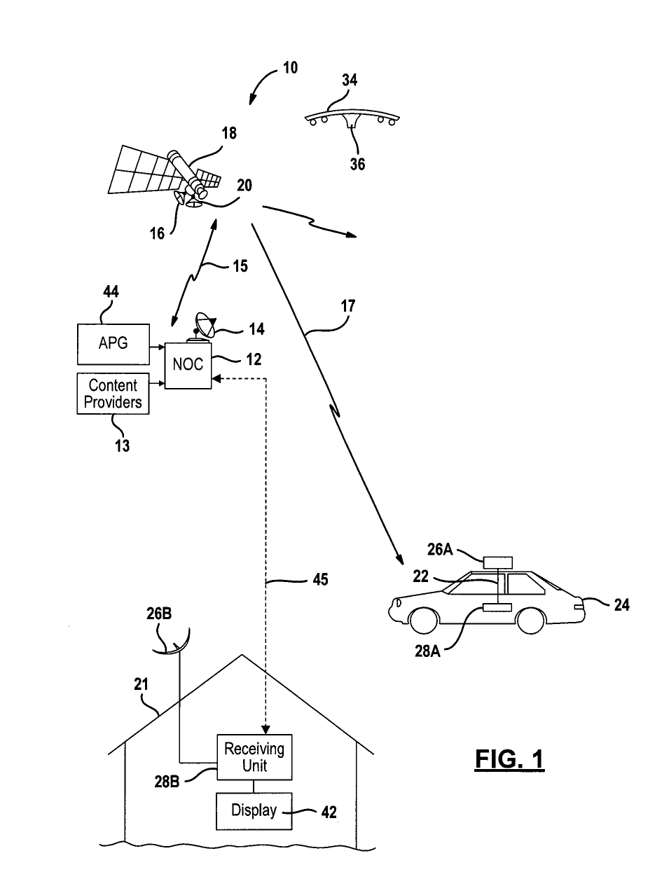

Referring now to FIG. 1, a satellite television broadcasting system 10 is set forth in the following example. The satellite television broadcasting system 10 includes a network operations center (NOC) 12 in communication with various content providers 13. The NOC 12 may also be referred to as a head end. Various programming content may be provided from the content providers 13 including television programs, movies, sporting events and the like. The content providers 13 may provide live feeds as well as recorded material. The content providers 13 may thus provide signals or media. The content may be in high definition, standard definition, three-dimensional television or combinations thereof.

The network operations center 12 generates wireless communication signals 15 through a transmitting antenna 14 which are received by a receiving antenna 16 of a high altitude device such as a spaced-based satellite 18. The wireless communication signals, for example, may be digital, digital video, data or digital audio. As will be described below, the wireless communication signals may be entertainment content, live content, traffic, weather, hazardous material warning areas or advertising marketing. The wireless signals 15 may be referred to as uplink signals.

Wireless communication signals 17 such as downlink signals may be generated from the satellite 18. The downlink signal corresponds in content to the uplink signals.

A transmitting antenna 20 of the satellite 18 communicates the downlink signals 17 to various receiving systems including a mobile receiving system 22A such as those in a vehicle and stationary system 22B such as those in a home 21. The wireless signals may also have various video and audio information associated therewith. The home 21 represents a building that may be a single family dwelling or multi-dwelling unit. The home 21 may also represent commercial building such as a hotel. Home 21 may include a plurality of receiving units that are each in communication with the antenna 26B.

The mobile receiving system 22A is disposed within an automotive vehicle 24. Several mobile receiving systems 22A may be incorporated into a network. The mobile receiving system 22A includes a receiving antenna 26A that receives the wireless signals 17 from the satellite 18 and processes the signals in a receiving unit 28A.

As mentioned above, the satellite system may be replaced with terrestrial wireless systems or wired (optical or electrical) and thus content may be received at the receiving unit through terrestrial wireless signal or signals through a wire or optical fiber.

The satellites 18 may also be replaced with another high altitude device such as a stratospheric platform 34 for transmitting content to the mobile device, transmitting communication signals, transmitting lost content segments and transmitting location-specific signals. Stratospheric platforms 34 are manned or unmanned airplanes, airships, or the like that fly above commercial airspace. It is envisioned that stratospheric platforms may fly at altitudes between 60,000 and 100,000 feet (in the stratosphere) from the surface of the earth. Thus, the stratospheric platforms are in a significantly lower position than even low earth orbit satellites.

The stratospheric platforms 34 may also include a transponding unit 36 that is used to receive and retransmit signals from the satellite 18. The transponding unit 36 may be referred to as a stationary unit since the stratospheric platform maintains a particular position above the earth. The receiving unit 36 may be used to transfer content segments or packets to another node of the device.

The home 21 may include a user receiving unit 28B that communicates with the satellite 18 through the antenna 26B. The receiving unit 28B may also be in communication with a display 42 such as a television.

An advanced program guide (APG) system 44 may provide available content data to or may be incorporated into the network operation center 12. The program guide system 44 organizes the set of available content data regarding the programming channels and organizes the data for ultimate transmission to the receiving devices including 28A, 28B. The receiving devices 28A, 28B may receive the available content data and display a grid guide using available content data. The program guide data may be referred to as program objects and may include a title, description, channel and time of broadcast. The program objects may also include identifiers for the type of program (movie, sports, series), a series or short identifier and an episode number for a series. As will be further described below, a content identifier, a Tribune Media Services® ID, a program information packet or another identifier may be used as an identifier for a particular program. These may be found in the data corresponding to the program guide system 44. The same or equivalent program or event may have the same or similar packet identifier, program-associated data, Tribune Media Services® ID or content identifier.

The APG system 44 may also provide various types of metadata as well as content posters. Posters are images that are provided to visually describe the content. For example, a movie poster is an image of a scene or a visual representation of the movie. Typically, a poster has a main character as well. A title may also be associated with an image and may be provided separately or just below an image.

The APG system 44, as mentioned above, provides metadata with the content. The metadata may also include ratings, such as television or motion picture association ratings, a channel identifier associated with a channel used for broadcasting, and other data such as actor data, producer data, a description and other information about a particular content. The metadata may also include a dollar amount for pay-per-view or on-demand content.

It should be noted that the APG 44 and NOC 12 may all be physically located in the network operations center 12 or other central location. The NOC 12 may also be referred to as a head end.

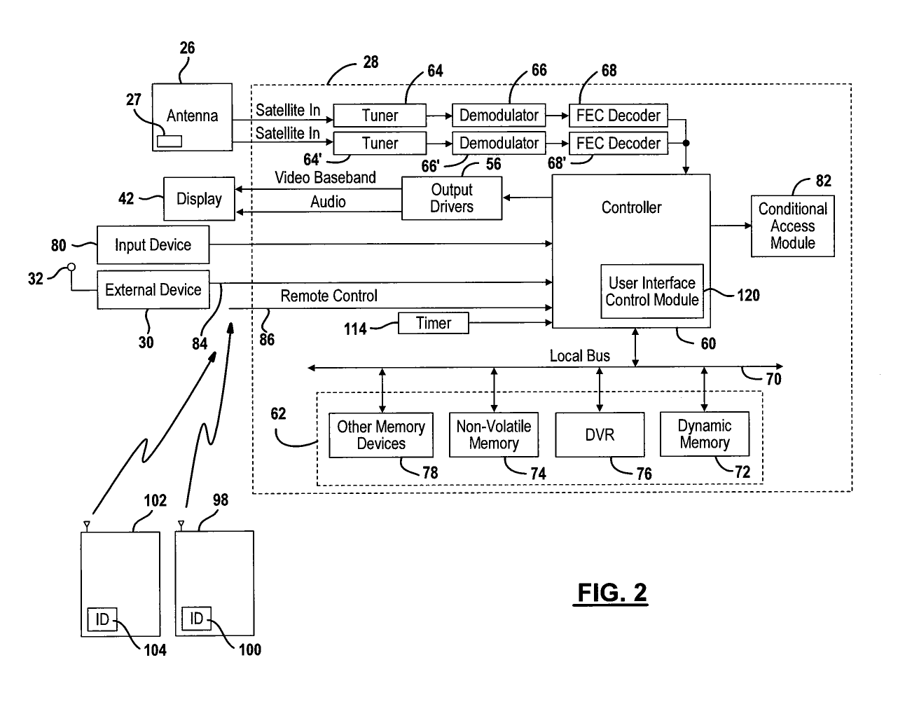

Referring now to FIG. 2, the mobile and stationary receiving units described above are collectively referred to as receiving unit 28 which is illustrated in further detail. The receiving units 28 may also be generally configured in a similar manner. The receiving units 28 may also be referred to as receiving devices, user devices or set top boxes. Antenna 26 may be various types of antennas including a rotating antenna which is used to track the relative movement of the satellite or other transponding device with respect to a vehicle. The antenna 26 may be a single fixed antenna used for satellite television reception for a building or home 21. The antenna 26 may also be an electronic antenna. The antenna 26 may include an internal controller 27 that controls the operation of the antenna 26, which is suitable for a moving or rotatable antenna.

The receiving unit 28 may include or be associated with the display 42 associated therewith. The display 42 may be incorporated into the unit 28 or may be external to the receiving unit such as part of a vehicle 24 or television. The display 42 may have output drivers 56 used for generating the desired audio and video outputs suitable for the particular display 42.

A controller 60 may be a general processor such as a microprocessor. The controller 60 may be used to coordinate and control the various functions of the receiving unit 28. Some modules within the controller are described further below. These functions may include but are not limited to controlling a tuner 64, a demodulator 66, a forward error correction decoder 68 and any buffers and other functions. The tuner 64 receives the signal or data from the individual channel. The demodulator 66 demodulates the signal or data to form a demodulated signal or data. The decoder 68 decodes the demodulated signal to form decoded data or a decoded signal. The controller 60 may be similar to that found in current DIRECTV® set top boxes which employ a chip-based multifunctional controller.

It should be noted that more than one tuner 64, demodulator 66 and forward error correction decoder 68 may be provided in the system. In this example, a second tuner 64′, a second demodulator 66′ and a second forward error correction decoder 68′ may be provided in the receiving unit 28. Of course, various numbers of tuners may be incorporated into a receiving unit 28.

The controller 60 may include or be coupled to a local bus 70. The local bus 70 may be used to couple a memory including dynamic memory 72 such as RAM which changes often and whose contents may be lost upon the interruption of power or boot up. The bus 70 may also be coupled to a non-volatile memory 74. The non-volatile memory 74 may be an in-circuit programmable type memory. One example of a non-volatile memory is an EEPROM. One specific type of EEPROM is flash memory. Flash memory is suitable since it is sectored into blocks of data segments that may be individually erased and rewritten. The non-volatile memory may include configuration settings for a remote control device.

A digital video recorder (DVR) 76 may also be coupled to the local bus 70 as part of the memory 62. The digital video recorder 76 may be within the receiving device 28 or coupled to the receiving device. The digital video recorder 76 may be used to store programming content or sub-contents.

Other memory devices 78 may also be coupled to local bus 70. The other memory devices may include other types of dynamic memory or non-volatile memory. The display 42 may be changed under the control of controller 60 in response to the data in the dynamic memory 72 or non-volatile memory 74. Part of the memory 62 may be used as a buffer.

The controller 60 may also be coupled to an input device 80 such as a keyboard, a stand-alone button or a touch screen. Should the unit 28 be incorporated into a vehicle, the input device 80 may be located external to the mobile receiving unit such as dial buttons, voice activated system, or the like incorporated into the vehicle and interface with the receiving unit. By performing an action with the input device 80, such as selecting a button, an action on the screen display may result. This includes changing the screen display, the menu in the screen display, selecting an item in the screen display and the like. The input device 80 may provide inputs for configuring a remote control device as will be described below.

A conditional access module 82 (CAM) may also be incorporated into the receiving unit. The access module 82 may include software to allow the receiving unit 28 access to various channels and wireless signals generated by the system. Not having an access card or not having an up-to-date access card 82 may prevent the user from receiving or displaying various content from the system.

One specific type of input device is a primary remote control device 98. The primary remote control device 98 may include various buttons such as numerical buttons, colored buttons, arrowed buttons and the like. The primary remote control device 98 may have an identifier (ID) memory 100 associated therewith. Upon the activation of one or more of the keys, dials, or devices, a primary remote control device identifier may be communicated to the receiving unit together with a key value that identifies a function to be performed by the receiving unit. One or more auxiliary remote control devices 102 may also be associated with a receiving unit 28. The auxiliary remote control device includes an auxiliary remote control device identifier memory 104. The remote control device identifier memory 104 has a different identifier than the identifier in the primary remote control device memory. The functions accessible within the receiving unit 28 may be limited for the auxiliary remote control device 102. Also, the number of buttons and dials may also be reduced from the primary remote control device 98.

A user interface control module 120 is incorporated into the controller 60. The user interface control module 120 is used for controlling the user interface or guide differently when inputs from different remote control devices are used. The user interface control module 120 is described in detail below.

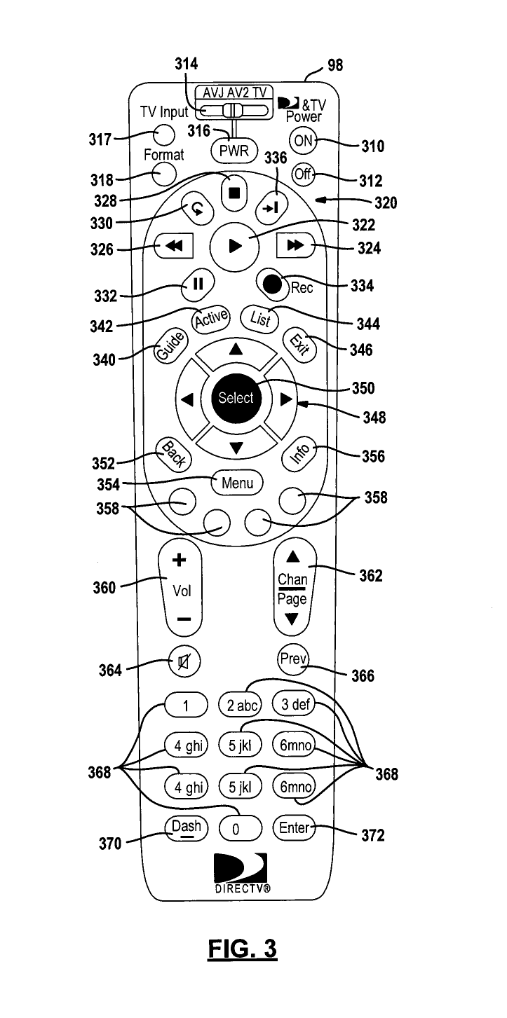

Referring now to FIG. 3, a primary remote control device 98 is illustrated. The primary remote control device may include various buttons and switches to provide key values to the set top box to provide various inputs. An ON button 310 and an OFF button 312 may be provided for turning on and off a television and receiving unit. A power button 316 may also be provided for turning on and off power to a device selected by the switch 314. A TV input button 317 may also be provided for providing an auxiliary input to the television. A format button 318 may be used for selecting the format of the screen display such as standard definition or high definition. A DVR control portion 320 may also be provided. The DVR control buttons may include a play button 322, a forward button 324, a reverse button 326, a stop button 328, a repeat button 330, a pause button 332, a record button 334, and a jump button 336. A guide button 340 may be used for displaying the program guide. An active button 342 may be used for accessing special features, services and information such as news. A list button 344 may be used to display a to-do list of programs. This may be associated with the digital video recorder. An exit button 346 exits the menu screen and the program guide. Arrow keys 348 may be used to move around in the program guide and various menu screens.

A select button 350 is used to choose or select a highlighted item in a menu or in a program guide. A back button 352 may be used to return to a previously displayed screen. A menu button 354 may be used to display a menu. An information button 356 may be used to display the current channel and program information when watching live television or in the guide. Color buttons 358 may be used to cycle through various available alternative audio tracks. The colored buttons may also give various functionality and various menus within the receiving unit.

A volume switch 360 may be used for increasing or decreasing the volume. The volume switch 360 may be a rocker switch. A channel or page button 362 may also be a rocker switch. The channel or page button 362 may be used to select the next higher or lower channel or higher or lower page in a program guide menu. A mute button 364 may also be provided. The mute button 364 may turn the sound from the receiving unit on or off. A previous button 366 may be used to return to the last viewed channel. Numerical buttons 368 may have a number and a letter assigned thereto. By selecting a number, a number key value may be provided to the receiving unit for inputting a particular number into a menu when making a selection. The number buttons 368 may also be used for providing letters into the receiving unit. For example, the “2” button may also have “A B C” associated therewith. A keypad for a telephone is similarly configured. A dash key 370 may be provided for inputting a dash for a sub-channel number. An enter button 372 may be used for entering the code in a menu.

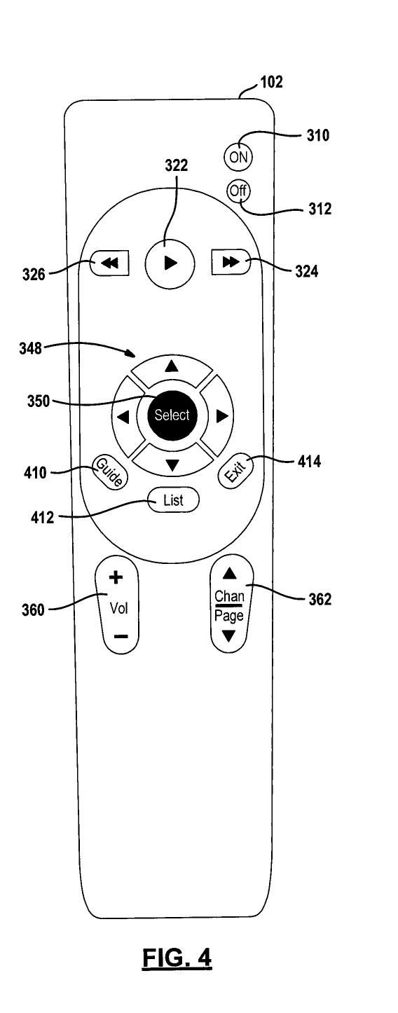

Referring now to FIG. 4, the auxiliary remote control device 102 is illustrated in further detail. As is illustrated, the auxiliary remote control 102 is significantly simplified and thus has substantially fewer buttons thereon. The on button 310, off button 312, reverse button 326, forward button 324 and play button 322 are all provided in the same position as those set forth for the primary remote control device. The arrow keys 348 are also provided on the remote control device as well as the select key 350. Volume button 360 and channel/page button 362 are also provided. Various types of remote controls having various numbers of buttons may be used in actual implementations using the teachings set forth herein. For example, more child-friendly remotes including fewer buttons and/or pictures may be used.

In a manufacturing environment, one common remote control circuit board (not shown) may be formed in the same way with the same circuitry. Each of the key values or codes corresponding to the positions of buttons may be identical in the primary and auxiliary remotes. As is illustrated, a guide button 410 is also provided. The guide button 410 is in the place of the back button 352 illustrated in FIG. 3. A list button 412 is also provided on the auxiliary remote 102 but in the position of the menu button 354 illustrated in FIG. 3. The exit button 414 is provided in the position of the info button 356 illustrated in FIG. 3. The key value provided by the buttons 410, 412 and 414 which correspond in position to the buttons 352, 354 and 356 illustrated in FIG. 3 may be the same. As will be described below, the receiving unit 28 will recognize the auxiliary remote control device and provide a different function for these buttons.

Referring now to FIG. 5, each of the remote control devices 98 and 102 illustrated in FIGS. 3 and 4 may be configured in a similar manner. That is, each remote control device may include a transmitter 510 that is used for transmitting a signal to the receiving unit 28 illustrated in FIGS. 1 and 2. The transmitter 510 may be one of a variety of different types of remote control transmitters including an infrared transmitter or an RF transmitter. The remote control device 98 or 102 also includes a controller 512. The controller 512 receives a signal from a button 514. Button 514 represents all the buttons in FIGS. 3 and 4. Only one button is illustrated in FIG. 5 for simplicity. The selection or operation of button 514 causes the controller 512 to obtain a key value signal or code from a key value table 516. The key value table 516 has a unique identifier for each of the buttons. The controller 512 also receives a remote control device identifier from a remote control device identifier memory 520, 100, 104. The controller 512 transmits a control word that includes a remote control device identifier and a key value from the key value table 516 upon every button push.

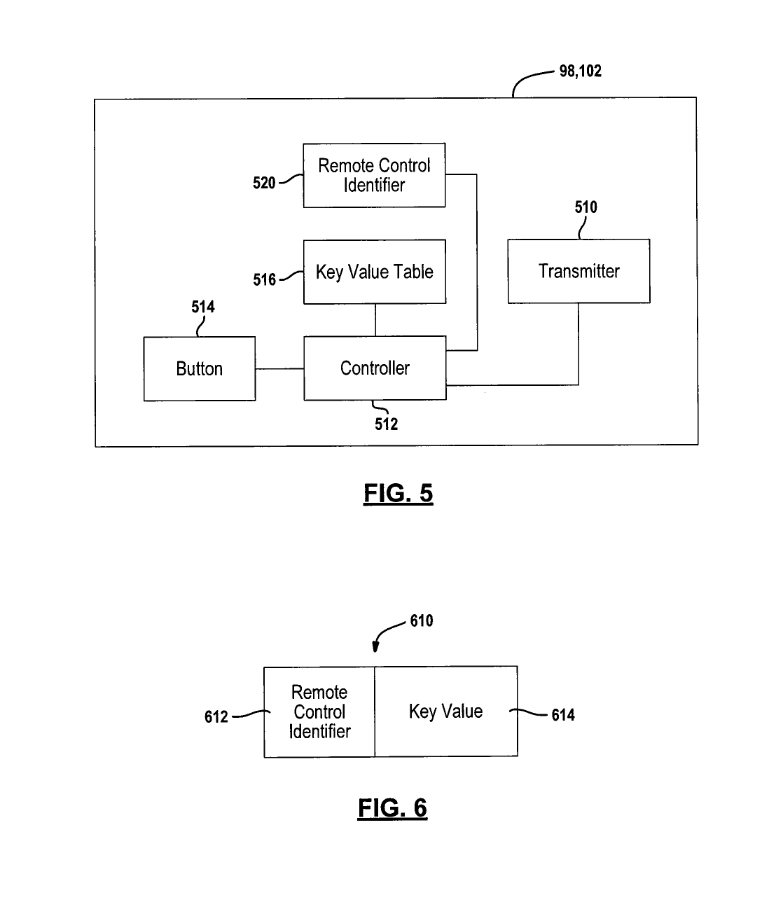

Referring now to FIG. 6, a control word 610 is illustrated having a remote control device identifier 612 and a key value 614. The remote control device identifier 612 identifies the remote control device so that the proper filter terms may be set as will be described below. The key value 614 corresponds to the value of the key or button selected on the remote control device. Every time a button is selected, a remote control device identifier 612 and a key value 614 may be transmitted to the receiving unit 28.

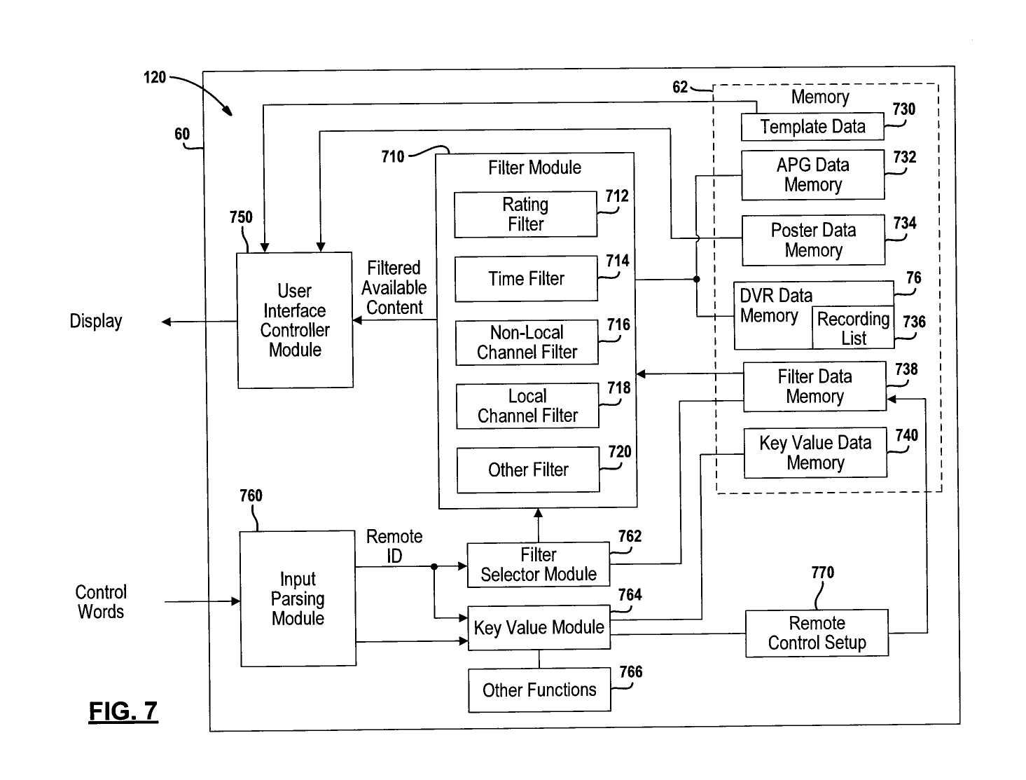

Referring now to FIG. 7, the user interface control module 120 of the controller 60 illustrated in FIG. 2 is provided in further detail. The controller 60 includes a filter module 710 that has a plurality of filter features therein. Each of the filters is a setting or multiple settings for filtering the set of available content data. The filter module 710 may include a rating filter 712 that filters the set of available content data based upon ratings. Rating filter 712 may be set to filter the available content data that has a rating greater than a predetermined or a set amount. For example, a set amount may be PG-13 so any higher ratings such as R and X may be filtered.

A time filter 714 may also be included as a filter feature within the filter module. The time filter 714 may filter the available content data for a predetermined or set time. Should the auxiliary remote control device be associated with a child, the filter time may be the bed time of the child after which no content is available. The filter time may define what times are to be included for viewing content for the particular auxiliary remote. The filter time may be set at different times for different days. For example, on Friday night or Saturday night the filter time may be set to 10:00 and the filter time on Sunday through Thursday nights may be set at 9:00 corresponding to the child's bed time. Thus, filter times may correspond to a day, time, or may be set generally to apply the same time “every day.” Content data out of the “allowed” times is excluded for being displayed in the user interface associated with the auxiliary remote.

The filter features of the filter module 710 may also include a non-local channel filter 716. The non-local channel filter 716 may allow the primary remote control device to select various channels to be available when the auxiliary remote control device is operated. Any channel not on a non-local channel list may be filtered from being displayed in the user interface generated by the receiving unit when the auxiliary remote control device is used.

The filter features of the filter module 710 may also include a local channel filter 718. The local channel filter 718 may filter out any local channels not selected by the operator of the primary remote control device when displaying the user interface associated with the auxiliary remote control device. Any local channel not selected will have the content data excluded from display in the user interface associated with the auxiliary remote.

Of course, other filters 720 may be incorporated into the filter module 710. Other filters may be provided for different uses or different groups.

The memory 62 illustrated in FIG. 2 is also illustrated in further detail. The memory 62 may have various types of data therein. The memory 62 illustrated in FIG. 2 was decided based on the type of memory. The memory 62 illustrated in FIG. 7 is with respect to function. The different types of memory in FIG. 2 could be used for the functional types of memory 730-740. The memory 62 may include template data 730 for generating a template to be filled in by a user interface controller 750. The template data 730 may have different template data including the grid guide bars, colors and other defining elements without respect to the content. A different template may be used for displaying user interface associated with the auxiliary remote.

The APG data memory 732 may include the program guide data that is received from the network operations center or head end. The program guide data, as mentioned above, has various types of metadata and other types of identifiers associated therewith that make the data suitable for filtering at the filter module 710. A poster data memory 734 may also be included within the memory 62. Poster data memory 734 may include data corresponding to poster data associated with the content available at the program guide data. Although the poster data memory 734 is illustrated as a separate memory, the poster data memory 734 may be incorporated into the program guide data memory 732.

The memory 62 may also have the DVR data memory therein. The DVR data may include content data for content recorded within the DVR 76. A recording list memory 736 has a recording list of the content data available for the content recorded within the DVR 76.

A filter data memory 738 may also be incorporated into the memory 62. The filter data memory 738 includes various filter settings corresponding to the auxiliary remote control devices. As mentioned above, a plurality of different remote control devices may be associated with a receiving unit.

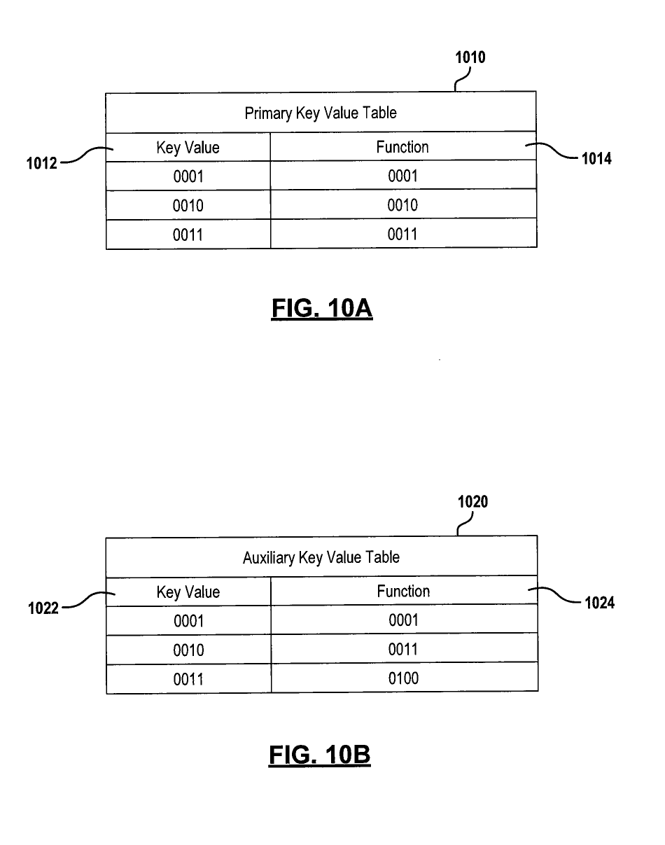

A key value data memory 740 includes a table corresponding to key values for the different remote control devices. For example, a primary remote control device and an auxiliary remote control device may have different functions associated with the key or button value. Referring back to FIGS. 3 and 4, when the key value associated with the list button 412 is communicated to the set top box, the key value is identical to the key value of the menu button 354 of FIG. 3. However, the function associated with the buttons is different. Thus, the key value data memory includes a key value and function associated with the key value. These may be represented as a table as is set forth below. Carrying through with the present example, when the auxiliary identifier is received, and the list button 412 is selected on the auxiliary remote, the same key value as the menu button 354 is communicated to the receiving unit. The key value data memory uses the primary remote control device identifier or the auxiliary remote control device identifier to choose the appropriate function associated with the respective remote control device by selecting the appropriate key value/function table described below in FIG. 10.

An input parsing module may also be disposed within the controller 60. The input parsing module receives the control words from the remote control devices 98, 102. The input parsing module 760 may separate the remote identifier and the key value. The remote identifier may be used to select a filter configuration using the filter selection module 762. The filter selection module 762 may communicate with the filter data memory 738 so that the proper filter data is provided within the filter module 710 for the respective remote control device.

A key value module 764 may also receive input from the input parsing module 760. The key value module 764 may receive key values from within the control word and using the key value data memory 740, determined the function associated therewith. The key value module 764 may provide the function to the controller so that other functions 766 may be performed. The key value module 764 may also prevent functions from being performed. For example, the use of the auxiliary remote control device may block various functions such as the programming of the filter features, changing receiving unit settings or accessing other receiving unit defaults and controls.

A remote control setup module 770 may also be disposed within the controller 60. The remote control setup module 770 may initiate screen displays for configuring the various filter features. The various filter features may be configured using the primary remote control device. After the remote control setup module 770 configures the controller 60 to recognize the auxiliary remote control, the filter data memory 738 is stored with the various values for the respective remote control device.

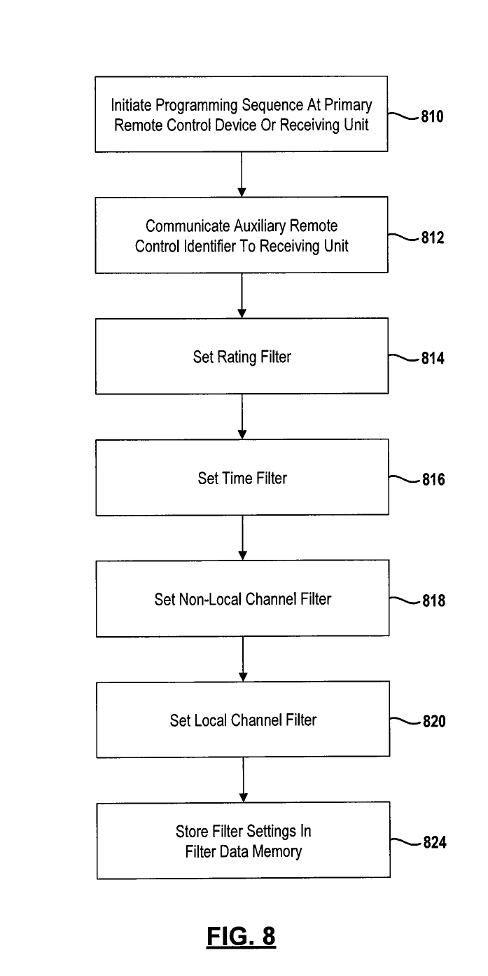

Referring now to FIG. 8, a method for programming the user interface associated with the auxiliary remote control device is set forth. The receiving unit is programmed to recognize the auxiliary remote control device and display the corresponding user interface. In step 810, programming sequence is initiated using the input device 80 of the receiving unit 28 illustrated in FIG. 2. The programming sequence may also be initiated using the primary remote control device 98. A primary remote control device identifier may therefore need to be received to initiate the programming sequence at the primary remote control device 98. When the remote setup module 770 illustrated in FIG. 7 receives the initiation of the program sequence, a screen display may be generated for communicating an auxiliary remote control device identifier to the receiving unit in step 812. The programming sequence may generate a screen display that allows the auxiliary remote control device to be selected by pushing one of the buttons on the auxiliary remote control device. Thereafter, the various filters are set. A user name may also be input at this stage for later display.

In step 814, a rating filter may be set. By setting the rating filter, content data having ratings higher than a predetermined rating may not be provided to the user of the auxiliary remote control device.

In step 816, a time filter may also be associated with an auxiliary remote control device. The time filter may have various times for various days associated therewith. A particular time may also be associated with a remote control device for each day. Content data and content in excluded times may not be displayed in the user interface.

In step 818, the non-local channel filters may be set. The non-local channel filters allow the user of the primary remote control device to select channels from which content may be viewed by the user of the auxiliary remote control device.

In step 820, the local channel filters may also be set. Local channel filters allow the user to select various local channels whose content will be made available to the user of the auxiliary remote control device.

After the filter settings are set in steps 814-820, the filter settings are stored in the filter data memory 738.

It should be noted that a rating filter, a time filter, a non-local channel filter, and a local channel filter are illustrated, more or fewer may be set. Of course, other types of filters may also be set during this process depending on various system design requirements.

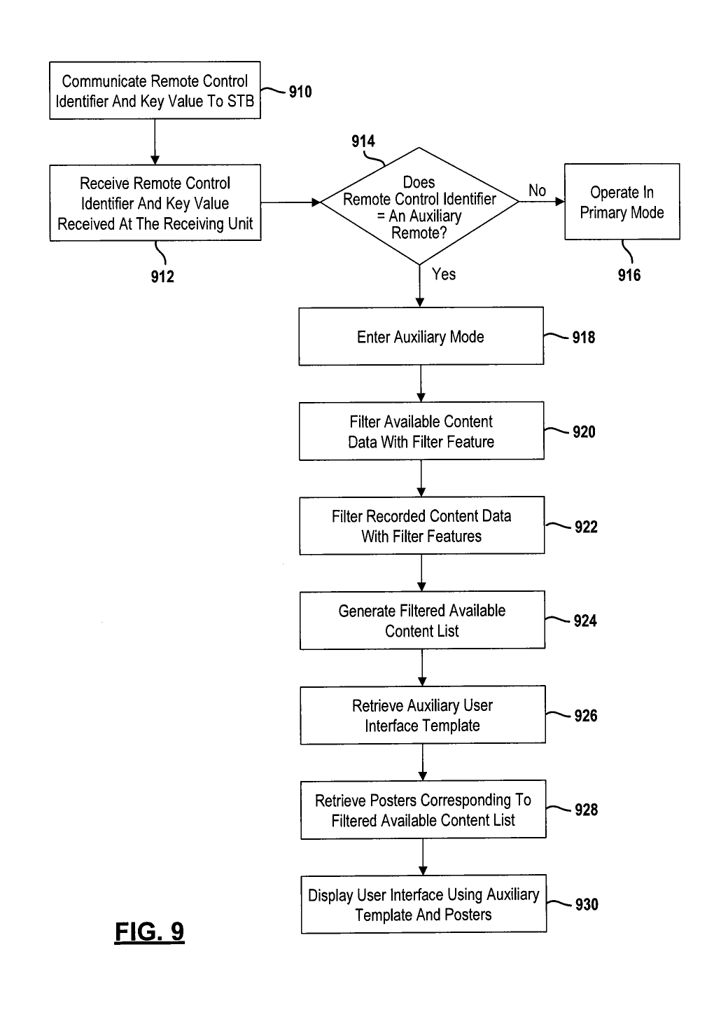

Referring now to FIG. 9, a method of generating a user interface display is set forth. In step 910, a remote control device identifier and key value are communicated to the set top box. This is performed when a button on a remote control device is selected or pushed. In step 912, the remote control device identifier and the key value associated with the button is received at the receiving unit. In step 914, if the remote identifier is not equal to an auxiliary remote, the remote control device is a primary remote control device and operates in primary mode as set forth in step 916. The primary mode allows access to all functions and settings.

Referring back to step 914, when the remote control device identifier is equal to an auxiliary remote control device, the receiving unit enters an auxiliary mode in step 918. The auxiliary mode is used to change the user interface from the standard program guide to an auxiliary user interface and block or prevent access of selected features of the receiving device. In step 920, the available content data is filtered with the filter feature or features selected for the auxiliary remote control device. As mentioned above, one or more of the filter features set forth above may be used in combination. The available content data is filtered. The available content data is obtained from the program guide data. The available content data corresponds to programs, movies and other types of content that is currently being broadcasted.

In step 922, recorded content data may also be filtered with the filter features. That is, content recorded in the digital video recorder may also be selected by the operator of the auxiliary remote. The recorded content data may be filtered using the same filter features used in step 920. Alternatively, a lesser number of filter features may be used. For example, the rating filter 712 may be used and the channel filter may not be used. In some embodiments, however, the originating channel may also be used for filtering the recorded content.

In step 924, a filtered available content list is generated from the currently broadcasted content data (filtered) and recorded content data. In step 926, an auxiliary interface template is retrieved from the memory. The auxiliary template may provide a different type of screen display as will be described below. In step 928, posters corresponding to the filtered available content list are also retrieved. In step 930, the display is generated using the auxiliary user interface template and the posters retrieved in step 928. A name may also be displayed.

As mentioned above, the screen displays may vary depending upon particular system requirements. For example, words rather than posters may be used to represent content. Other types of pictures or thumbnails may also be used to represent content.

Referring now to FIG. 10A, a primary key value table 1010 is provided. As mentioned above, when an auxiliary remote control device is used, the functions may be remapped according to the changed locations buttons. The receiving unit recognizes the auxiliary remote control device identifier and may change the corresponding function. The primary key value table 1010 may be located in the key value data memory 740 illustrated in FIG. 7. The primary key value table 1010 may include a key value 1012 and a corresponding function 1014. In this example, binary code 0001 corresponds to function 0001. Binary key value 0010 corresponds to function 0010 and key value 0011 corresponds to function 0011.

Referring now to FIG. 10B, an auxiliary key value table 1020 may be used when an auxiliary remote control device identifier is received at the receiving unit. In this example, a key value 1022 and a function value 1024 may be provided. In this example, key value 0001 corresponds to function 0001. However, key value 0010 now corresponds to function 0011 and key value 0011 corresponds to function 0100. Thus, the second and third rows of the auxiliary key value table 1020 have been remapped to alternate functions.

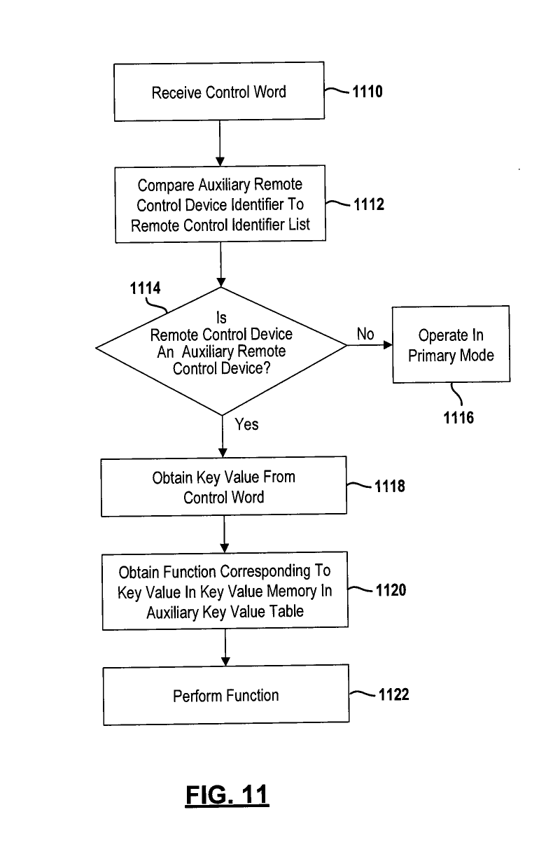

Referring now to FIG. 11, a method of operating with the auxiliary remote control device with the remapped key values is set forth. In step 1110, a control word is received from a remote control device at the receiving unit. In step 1112, the auxiliary remote control device identifier is compared to a remote control device identifier list. In step 1114, it is determined whether the remote control device is an auxiliary remote. If the remote control device is not an auxiliary remote, the receiving unit is operated in a primary mode in step 1116.

After step 1114, if the remote control device is an auxiliary remote control device, step 1118 obtains the key value from the control word. In step 1120, the function corresponding to the key value is obtained in the auxiliary key value table. In step 1122, the controller of the receiving unit performs the function for the key value obtained in step 1120.

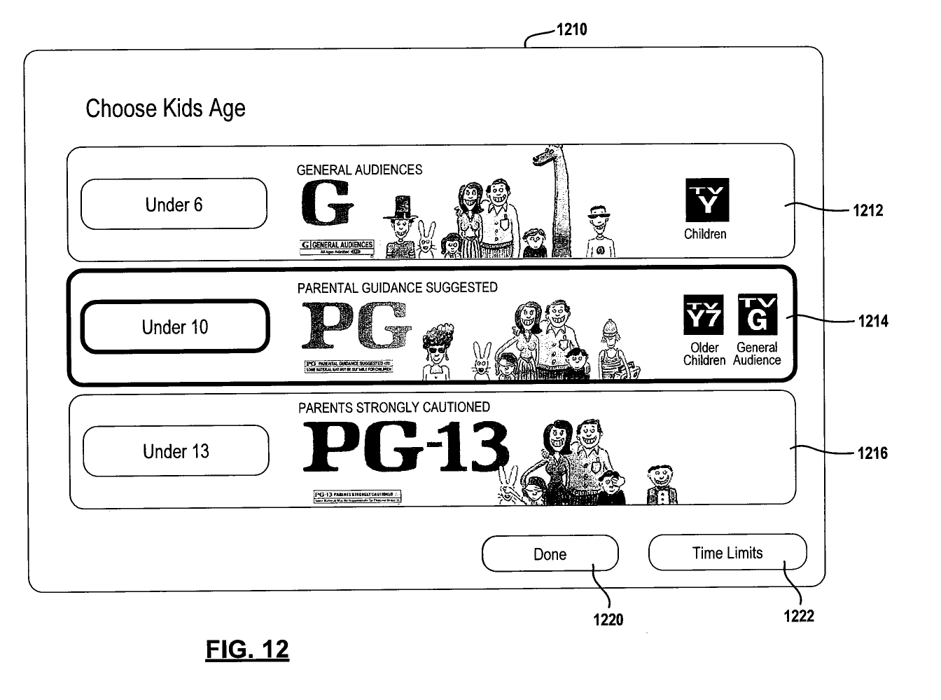

Referring now to FIG. 12, an example of a setup wizard for configuring the receiving unit to operate with an auxiliary remote is set forth. In the present example, the auxiliary remote corresponds to a child remote. However, other types of restrictions for other types of groups may be provided. For example, elderly or handicapped people may also desire an auxiliary remote for simplicity. A screen display 1210 for setting the rating filter features is illustrated having three selection boxes 1212, 1214 and 1216. In this example, the primary remote control device may use the arrow keys to select one of the boxes 1212-1216. In this example, box 1212 corresponds to children under six. This corresponds to a motion picture association rating of “general audience” and a television rating of “Y.” Box 1214 corresponds to children under 10 and corresponds to a motion picture association rating of “parental guidance” and a television rating of “Y7” and “G.” Box 1216 corresponds to children under 13 and corresponds to a motion picture association rating of “PG-13.” The television ratings associated with box 1216 may be set as TV-14. When the appropriate age group has been chosen, the wizard rating may be exited by selecting the done button 1220. In addition to the children's age, which corresponds to the rating limits, time limits may also be set in the setup wizard by selecting button 1222. Based on the rating selected, content data will be excluded from display in the user interface when the rating of the content is above the filter feature settings.

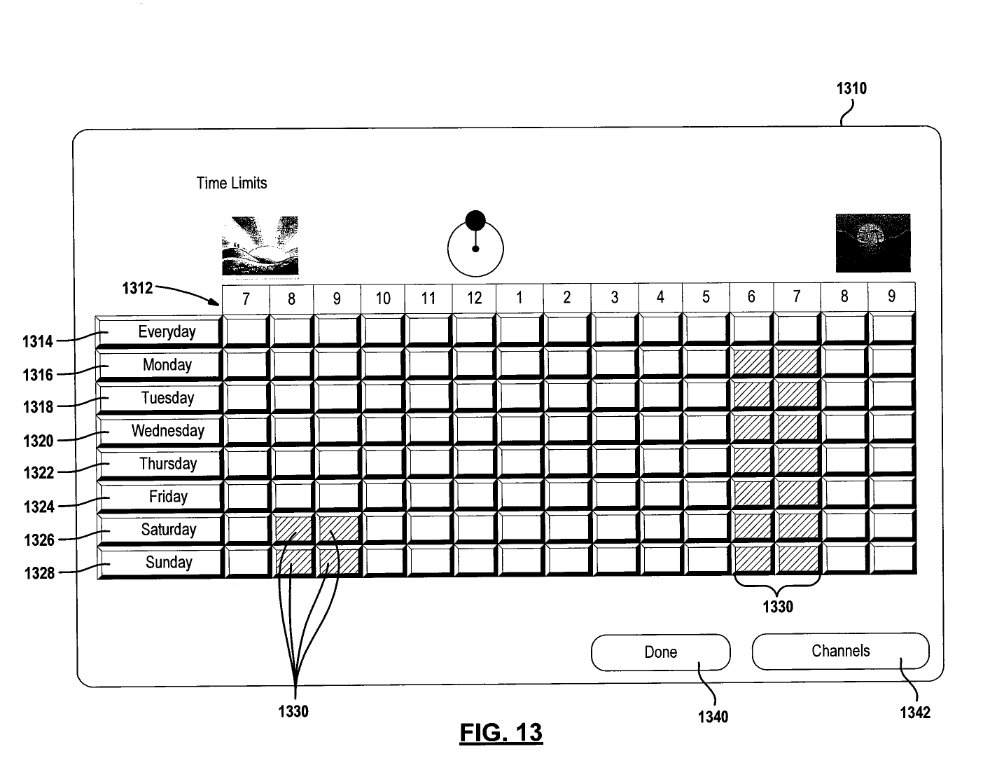

Referring now to FIG. 13, a screen display 1310 for selecting filter features of time limits is set forth. In this example, a row of times 1312 corresponding to columns for the 7:00 a.m. through 9:00 p.m. hours is set forth. The rows are labeled as every day 1314, Monday 1316, Tuesday 1318, Wednesday 1320, Thursday 1322, Friday 1324, Saturday 1326 and Sunday 1328. Thus, the screen display 1310 is provided with every day options or options for different days of the week. This gives the option for setting weekend times or other times during the week to different times than other days. In this example, the 8:00 a.m. hour and 9:00 a.m. hour are selected only for Saturday and Sunday. The 6:00 p.m. hour and 7:00 p.m. hour are also selected for Monday through Sunday. By moving a selection cursor around the screen, each of the individual boxes may be selected or deselected. Selected boxes 1330 are cross-hatched in FIG. 13. These may be represented by a color on the television display. Content data outside of selected times will not be displayed. After the time limits have been set, the wizard may be exited using the done button 1340. However, the channels may also act as a filter. By selecting the channels button 1342, a channels menu is provided.

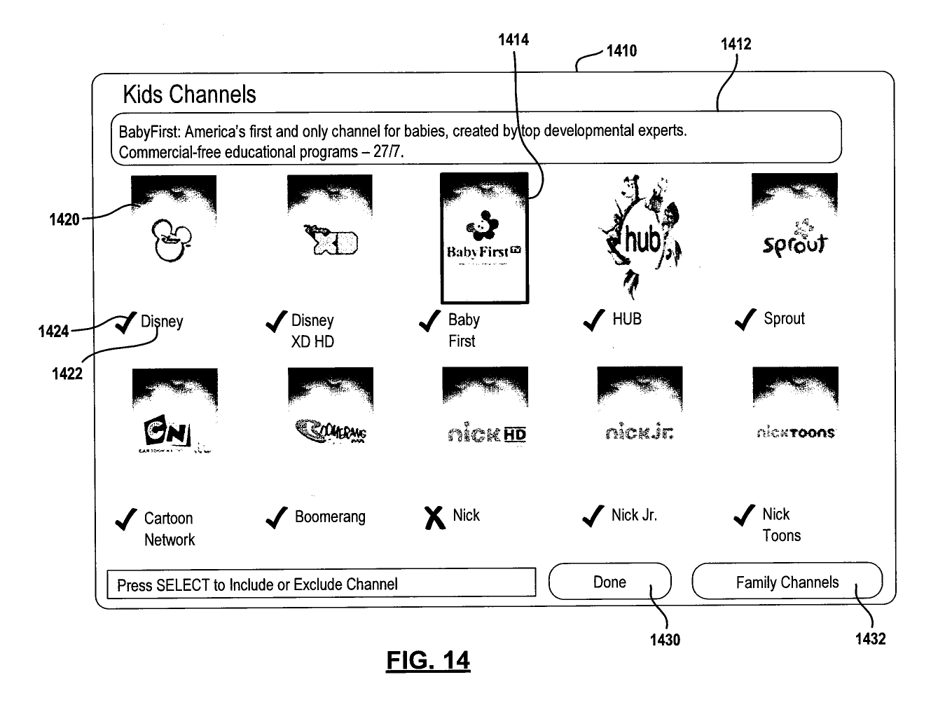

Referring now to FIG. 14, a channel selection screen display 1410 is illustrated. In this example, a plurality of kids' channels is displayed. A description box 1412 may also provide a description of a channel selected. In this example, the “Baby First” network has been selected by a selection box 1414. Each of the channels present may include a thumbnail 1420 and a title 1422. An indicator 1424 may indicate whether or not a particular channel has been selected. In this example, a check is used for indicating the channel has been selected and an “X” is used to indicate a channel has not been selected. These functions may be performed using the primary remote control device. Channels not selected will not have content data displayed in the user interface associated with the receiving unit. When the children's channels have been selected, box 1430 may be selected to indicate the programming wizard is to be exited. However, if further “family channels” are to be selected, box 1432 may be selected.

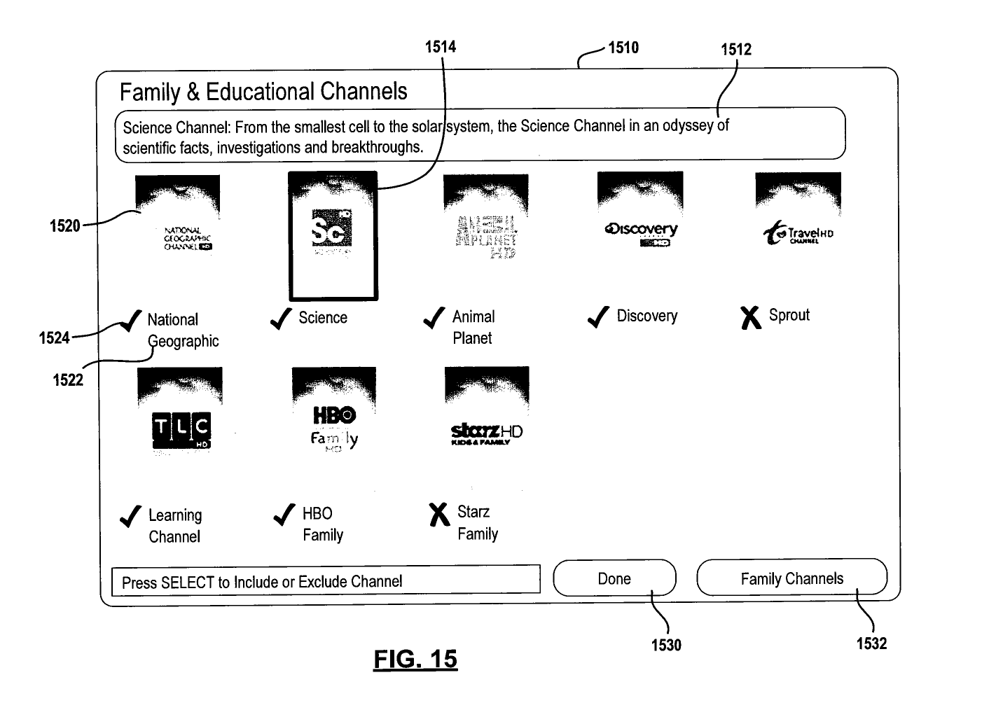

Referring now to FIG. 15, a screen display 1510 for selecting family and educational channel filter features is set forth. In this example, a description box 1512 providing a description of a selected channel by a selection box 1514 is set forth. In this example, a thumbnail 1520 and a title 1522 are provided. An indicator 1524 is also provided to indicate the selection or non-selection of the particular channel. When the family and educational channels are completed, the family and educational channels not selected are excluded from being displayed in the user interface associated with the auxiliary remote control device. The configuration wizard may be exited by selecting the done box 1530. However, local channels may also be selected or deselected by selecting the local channels box 1532.

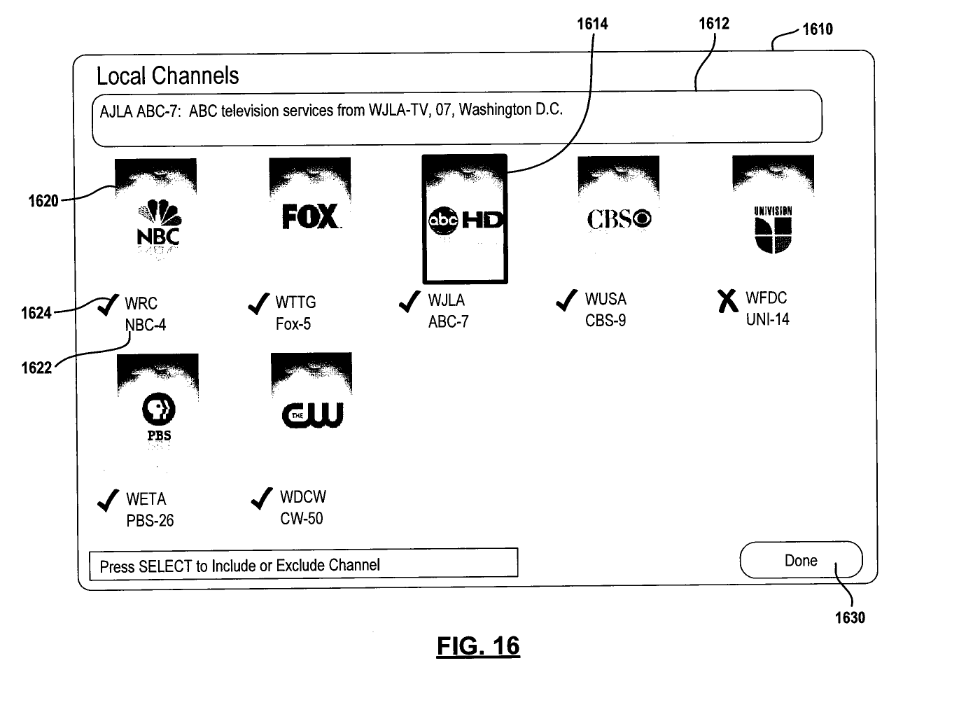

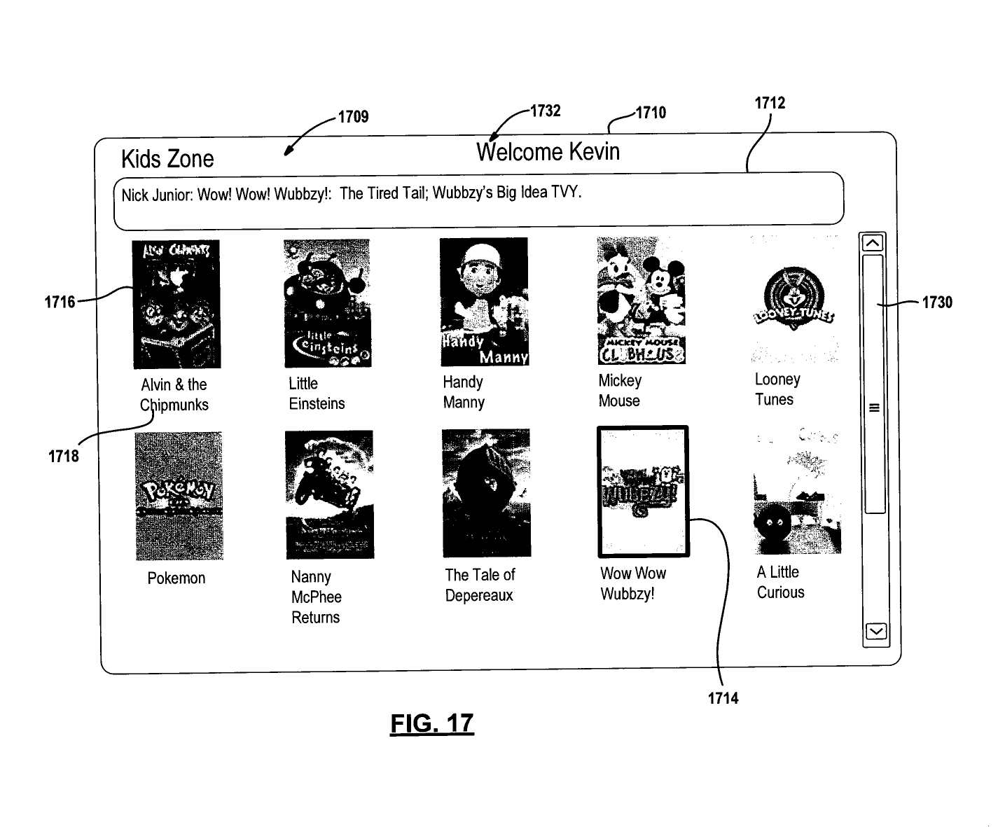

Referring now to FIG. 16, a screen display 1610 for selecting local channel filter features is set forth. A description box 1612 may be generated for providing a description of the particular channel selected by the selection box 1614. In this example, thumbnails 1620 and a title 1622 are provided. An indicator 1624 is provided for indicating a selected or deselected channel.

In FIGS. 13-16, the available channel data may be obtained from the program guide and recorded content data. Only channels that the user is subscribed to may be displayed for selection. In this example, selecting the local channels corresponds to the end of the programming wizard and thus the done box 1630 may be selected for exiting the auxiliary remote control device channel configuration wizard.

Referring now to FIG. 17, a screen display 1710 illustrates an example of a screen display of a user interface 1709 that would be displayed to the user of the auxiliary remote control device. In this example, a description box 1712 is provided for a selected poster indicated by the box 1714. A plurality of posters 1716 is displayed for the filtered content. As mentioned above, both current content data and recorded content data may be provided as choices in the screen display 1710. Each television show, movie or other type of content may have the poster 1716 corresponding thereto displayed on the screen as well as a title 1718. Thus, the posters 1716 correspond to currently available content or a television program or movie that has been recorded within the digital video recorder. A slide dial 1730 may be used to scroll up or down if too many posters than the number that will fit on the screen display 1710 are available. In this example, 10 posters 1716 are displayed along with a corresponding title 1718.

A screen name 1732 that corresponds to the name entered when programming the remote may also be displayed.

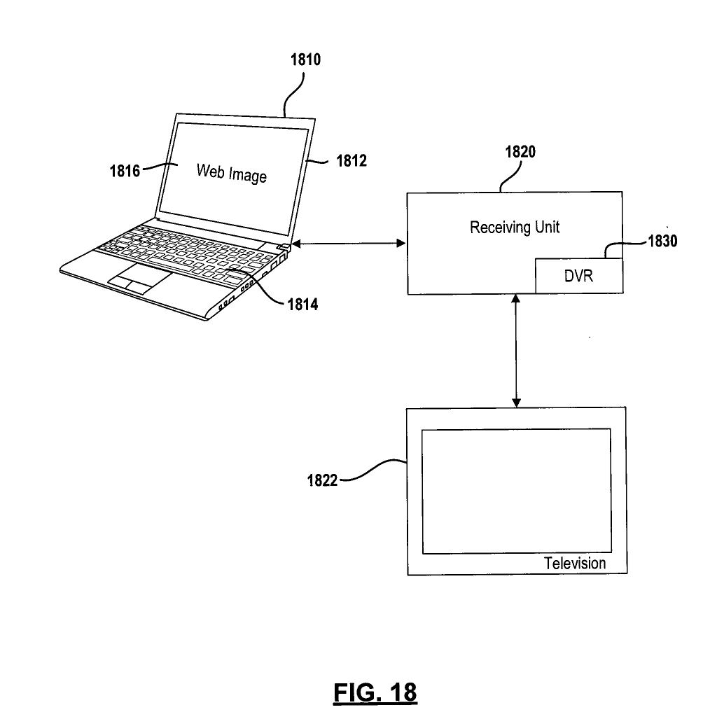

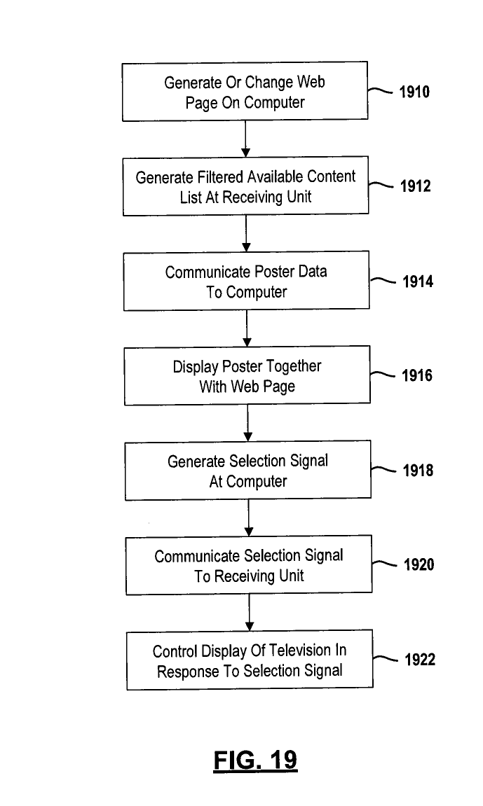

Referring now to FIG. 18, a configuration for testing the above is set forth. In this example, a computer 1810 is provided. The computer may be a laptop computer or a desktop computer. The computer includes a screen display 1812 and an input device 1814 such as a computer or a mouse. The computer 1810 displays a web page 1816.

The computer 1810 is in communication with a receiving unit 1820. The receiving unit is also in communication with a television 1822. The television 1822 may also be a monitor or other type of screen display. When generating a new user interface, it is often difficult to change screen displays provided by the receiving unit 1820. The present configuration allows a web page 1810 to be generated so that different configurations may be generated or experimented with in a testing environment. The receiving unit 1820 generates data such as the programs currently available and collects poster data in a similar manner to the receiving unit described above. Although, in a testing environment the receiving unit 1820 may have a predetermined set of content stored therein. The receiving unit 1820 may also have a digital video recorder 1830 therein for storing recorded content therein.

When content is selected at the computer 1810, a control command is processed by the receiving unit and generates a screen display on the television 1822. In this manner, the channel or content may be selected at the computer 1810 and the content may be watched on the television 1822.

Referring now to FIG. 19, a method for operating the testing configuration illustrated in FIG. 18 is set forth. In step 1910, a web page is generated on the computer 1810. The web page may be generated therein or may be communicated from the receiving unit 1820. In step 1912, the receiving unit generates a filtered available content list. In step 1914, the posters corresponding to the filtered available content list are communicated to the computer 1810. The posters may be used to fill places in the web page 1816. Thus, the user of the computer 1810 sees the posters overlaid on the web page 1816 in step 1916. In step 1918, a selection of content by selecting a content poster may be performed at the computer 1810. The user interface 1814 of the computer 1810 may be used to form the selection. In step 1920, a selection signal is communicated to the receiving unit 1820. The receiving unit 1820 controls the television 1822 to display the content corresponding to the selection signal. In this manner, the computer 1810 may be used to control the receiving unit 1820 which in turn controls the displayed content at the television 1822.

Those skilled in the art can now appreciate from the foregoing description that the broad teachings of the disclosure can be implemented in a variety of forms. Therefore, while this disclosure includes particular examples, the true scope of the disclosure should not be so limited since other modifications will become apparent to the skilled practitioner upon a study of the drawings, the specification and the following claims.

What is claimed is:

1. A method of operating a receiving unit comprising:
selecting a filter feature for filtering content data from a set of available content data for use with an auxiliary remote control device;
receiving an auxiliary remote control device identifier from auxiliary remote control device at a receiving unit;
in response to receiving the auxiliary remote control device identifier, filtering the set of available content data with the filter feature to form filtered available content data less than the set of available content data; and
displaying a user interface having the filtered available content data associated with the auxiliary remote control device on a display.

2. A method as recited in claim 1 wherein selecting comprises selecting the filter feature using a primary remote control device.

3. A method as recited in claim 2 further comprising remapping first functions associated with the primary remote control device to form second functions associated with an auxiliary remote control device.

4. A method as recited in claim 1 wherein selecting comprises selecting the filter feature using a receiving unit input device.

5. A method as recited in claim 1 wherein selecting a filter feature comprises selecting a channel filter and wherein displaying a user interface comprises displaying filtered available content data in the user interface in response to the channel filter.

6. A method as recited in claim 1 wherein selecting a filter feature comprises selecting a rating filter and wherein displaying a user interface comprises displaying filtered available content data in the user interface in response to the rating filter.

7. A method as recited in claim 1 wherein selecting a filter feature comprises selecting a local channel filter and wherein displaying a user interface comprises displaying filtered available content data in the user interface in response to the local channel filter.

8. A method as recited in claim 1 wherein selecting a filter feature comprises selecting a non-local channel filter and wherein displaying a user interface comprises displaying filtered available content data in the user interface in response to a non-local channel filter.

9. A method as recited in claim 1 wherein selecting a filter feature comprises selecting a time filter wherein displaying a user interface comprises displaying filtered available content data in the user interface in response to the time filter.

10. A method as recited in claim 1 wherein filtering the set of available content comprises filtering the set of available content data from program guide data.

11. A method as recited in claim 1 wherein filtering the set of available content comprises filtering the set of available content data from recording list data.

12. A method as recited in claim 1 wherein displaying the user interface comprises displaying posters corresponding to the filtered available content in the user interface.

13. A method as recited in claim 1 further comprising entering an auxiliary mode at the receiving unit in response to the auxiliary remote control device identifier, communicating a key value to receiving unit, changing the function associated with the key value in response to the auxiliary remote control device identifier and an auxiliary key value table.

14. A method as recited in claim 1 further comprising selecting one of the filtered available content on the display using the auxiliary remote control device.

15. A method as recited in claim 14 further comprising tuning the receiving unit in response to selecting one of the filtered available content.

16. A method as recited in claim 14 further comprising displaying content from a digital video recorder in response to selecting one of the filtered available content.

17. A system comprising:
an auxiliary remote control device having an auxiliary remote control device identifier associated therewith; and
a receiving unit comprising a filter module having a filter feature for filtering content data from a set of available content data in response to an auxiliary remote control device identifier received at the receiving unit, said filter module forming filtered available content data less than the set of available content data; and
said receiving unit displaying a user interface having the filtered available content data associated with the auxiliary remote control device on a display associated with the receiving unit.

18. A system as recited in claim 17 further comprising a primary remote control device selecting the filter feature.

19. A system as recited in claim 18 wherein the receiving unit remaps first functions associated with the primary remote control device to form second functions associated with an auxiliary remote control device.

20. A system as recited in claim 17 wherein a receiving unit input device selects the filter feature.

21. A system as recited in claim 17 wherein the filter feature comprises a channel filter and wherein the receiving unit displays the user interface in response to the channel filter.

22. A system as recited in claim 17 wherein the filter feature comprises a rating filter and wherein the receiving unit displays the user interface in response to the rating filter.

23. A system as recited in claim 17 wherein the filter feature comprises a local channel filter and wherein the receiving unit displays the user interface in response to the local channel filter.

24. A system as recited in claim 17 wherein the filter feature comprises a non-local channel filter and wherein the receiving unit displays the user interface in response to the non-local channel filter.

25. A system as recited in claim 17 wherein the filter feature comprises a channel filter and wherein the receiving unit displays the user interface in response to the channel filter.

26. A system as recited in claim 17 wherein the set of available content data comprises program guide data.

27. A system as recited in claim 17 wherein the set of available content data comprises recording data.

28. A system as recited in claim 17 wherein the receiving device displays posters corresponding to the filtered available content data on the display.

29. A system as recited in claim 17 wherein the receiving unit enters an auxiliary mode in response to the auxiliary remote control device identifier and changes a function associated with a key value received from the auxiliary remote in response to the auxiliary remote control device identifier and an auxiliary key value table.

30. A system as recited in claim 17 wherein the auxiliary remote control device selects one of the filtered available content on the display.

31. A system as recited in claim 30 wherein the receiving unit is tuned in response to selecting one of the filtered available content using the auxiliary remote control device.

32. A system as recited in claim 31 further comprising playing content from a digital video recorder in response to selecting one of the filtered available content data.
